(19) United States
(12) Patent Application Publication
(10) Pub. No.: US 2019/0317323 A1
(43) Pub. Date: Oct. 17, 2019

(54) HEAD-UP DISPLAY DEVICE

(71) Applicant: DENSO CORPORATION, Kariya-city (JP)

(72) Inventor: Ryo YAMAOKA, Kariya-city (JP)

(21) Appl. No.: 16/455,814

(22) Filed: Jun. 28, 2019

Related U.S. Application Data
(63) Continuation of application No. PCT/JP2017/046317, filed on Dec. 25, 2017.

(30) Foreign Application Priority Data
Jan. 10, 2017 (JP) 2017-002070

(51) Int. Cl. G02B 27/01; F21V 8/00

(52) U.S. Cl. CPC G02B 27/0101; G02B 6/0045; G02F 1/133528; G02B 2027/0118; G02B 2027/011

(57) ABSTRACT

A Head-up display device (HUD device) is mounted on a mobile body and projects an image to a windshield to display the image as a virtual image visible by an occupant. The HUD device includes a light-emitting display having a display screen and displaying an image by emitting light, and a reflector that reflects the light from the display screen toward the windshield to adjust the formation state of the virtual image. The display screen is curved.

### CROSS REFERENCE TO RELATED APPLICATIONS

The present application is a continuation application of International Patent Application No. PCT/JP2017/046317 filed on Dec. 25, 2017, which designated the United States and claims the benefit of priority from Japanese Patent Application No. 2017-002070 filed on Jan. 10, 2017. The entire disclosures of all of the above applications are incorporated herein by reference.

### TECHNICAL FIELD

The present disclosure relates to a head-up display device (hereinafter abbreviated as HUD device) mounted on a mobile body.

### BACKGROUND

HUD devices mounted on mobile bodies have hitherto been known. Such device is of a type known as a laser scanner system, which includes a projector that oscillates a laser beam, and projects and scans the laser beam, and a reflector that reflects the light projected from the projector to a projection member to adjust a formation state of a virtual image.

HUD devices include other known types than the laser scanner system, such as a system in which virtual images are displayed by a light-emitting display. The device includes a liquid crystal light-emitting display having a flat display screen that displays images by emitting light, and a reflector that reflects light from the display screen toward a projection member to adjust a formation state of the virtual image.

### SUMMARY

According to at least one embodiment of the present disclosure, a head-up display device is mounted on a mobile body and projects an image to a projection member to display the image as a virtual image visible by an occupant in the mobile body. The head-up display device includes a light-emitting display that includes a display screen and emits light through the display screen to display an image, and a reflector that reflects the light from the display screen toward the projection member to adjust a formation state of the virtual image. The display screen is curved.

### BRIEF DESCRIPTION OF THE DRAWINGS

FIG. 1 is a diagram illustrating a HUD device according to at least one embodiment when mounted on a vehicle.

FIG. 2 is a diagram illustrating a HUD device according to at least one embodiment.

FIG. 3 is a diagram of an optical path formed by a HUD device according to at least one embodiment and a windshield.

FIG. 4 is a diagram illustrating a light-emitting display according to at least one embodiment.

FIG. 5 is an enlarged view illustrating part of a display screen of at least one embodiment to a larger scale.

FIG. 6 is a diagram illustrating a HUD device according to Comparative Example 1.

FIG. 7 is a diagram illustrating a HUD device according to Comparative Example 2.

FIG. 8 is a diagram illustrating one example of a light-emitting display according to at least one embodiment.

FIG. 9 is a diagram illustrating another example of a light-emitting display according to at least one embodiment.

FIG. 10 is a diagram illustrating a light-emitting display according to at least one embodiment.

FIG. 11 is a diagram illustrating a light-emitting display according to at least one embodiment.

FIG. 12 is a diagram of an optical path formed by a HUD device according to at least one embodiment and a windshield.

FIG. 13 is a diagram for explaining Variation Example 3.

FIG. 14 is a diagram illustrating a light-emitting display according to Variation Example 7.

### DETAILED DESCRIPTION

In general, it is difficult and impractical to make improvements in other parts than the reflector (e.g., configuration for oscillating a laser beam) in laser scanning HUD devices for improvement of visibility of virtual images.

On the other hand, it is now the common practice to adopt a flat display screen in a HUD device that displays a virtual image using a light-emitting display. The present inventor has come upon the idea of modifying the shape of the display screen. The present inventor has then found that there is some room for improvement in visibility of a virtual image by refining the display screen.

The present disclosure provides a head-up display device that can realize high visibility of a virtual image with the use of a light-emitting display.

According to at least one embodiment of the present disclosure, a head-up display device is mounted on a mobile body and projects an image to a projection member to display the image as a virtual image visible by an occupant in the mobile body. The head-up display device includes a light-emitting display including a display screen and displaying an image by emitting light through the display screen, and a reflector that reflects the light from the display screen toward the projection member to adjust a formation state of the virtual image. The display screen is curved.

Accordingly, the display screen of the light-emitting display is formed as a curved surface. The display screen being curved enables reduction of display distortions such as field curvatures and distortion aberrations, for example, and, in combination with the shape and structure of the reflector, allows for adjustment of the display size of the virtual image. Thus, the HUD device that uses a light-emitting display can realize high visibility of a virtual image.

Hereinafter, various embodiments for carrying out the present disclosure will be described with reference to the drawings. Some parts in the embodiments may be given the same reference numerals when they are equivalent to elements already described in previous embodiments, thereby to omit repetitive description. When only some parts of a configuration are described in each embodiment, the description of the configuration of other previously described embodiments may be applied to the other features of the configuration. In addition to the combinations of parts specifically shown in the respective embodiments, the embodiments can be partly combined even if not explicitly suggested, unless such combinations are contradictory.

### First Embodiment

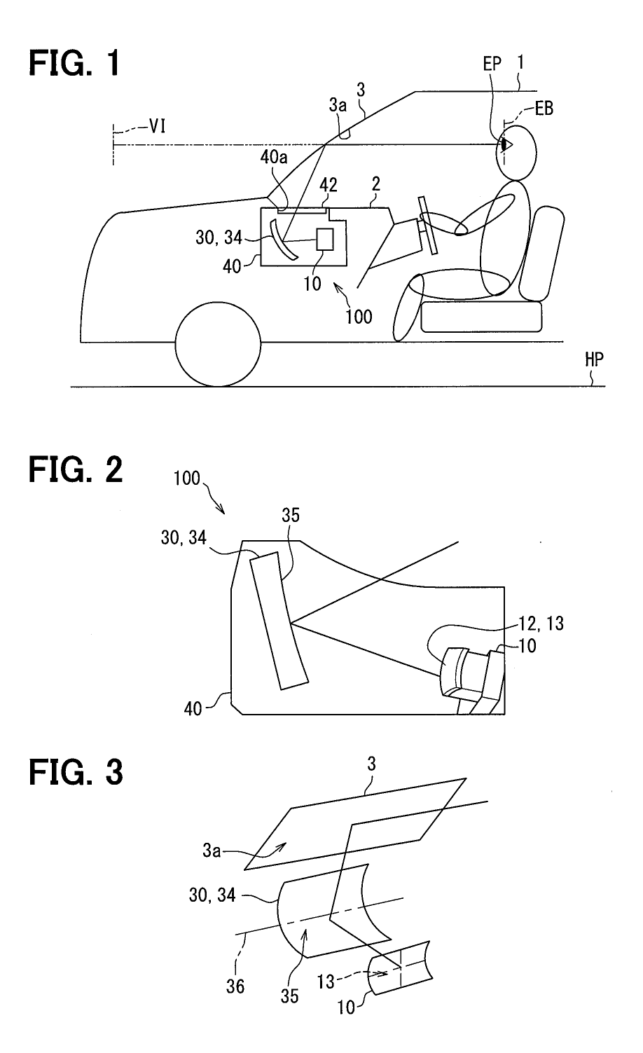

As shown in FIG. 1, a HUD device 100 according to the first embodiment of the present disclosure is mounted on a vehicle 1 that is one type of mobile body, and accommodated inside an instrument panel 2. The HUD device 100 projects an image to a windshield 3 serving as a projection member of the vehicle 1. The HUD device 100 thus displays an image as a virtual image VI visible by an occupant. Namely, as the light of the image reflected by the windshield 3 reaches a viewing region EB set in the interior of the vehicle 1, the occupant having an eye point EP located within the viewing region EB perceives this light as a virtual image VI. Thus, the occupant can recognize various information displayed as virtual images VI. Examples of various information displayed as the virtual image VI include vehicle status parameters such as a vehicle speed, an amount of remaining fuel, and the like, road information, or vehicle information such as vision assist information.

In the description below, directions such as above or below with respect to the vehicle, up and down directions of the vehicle, front or back of the vehicle, front to back directions of the vehicle, left to right directions of the vehicle, and the like, are defined on the basis that the vehicle 1 is positioned on a horizontal plane HP.

The windshield 3 of the vehicle 1 is formed as a transparent plate from glass or synthetic resin, for example, and disposed above the instrument panel 2 of the vehicle. The windshield 3 forms a smooth concave or flat surface as a projection surface 3a on which the light of the image is projected. The projection surface 3a faces downward and rearward of the vehicle.

The viewing region EB is a spatial region where the virtual image VI displayed by the HUD device 100 is visible, and is also called an eye-box. Typically, the viewing region EB is provided such as to overlap an eye range or “eyelips” set in the vehicle 1. The eyelips is set based on an eye range that represents statistic distributions of occupant eye points.

Specific configurations of such a HUD device 100 will be described below with reference also to FIG. 2 to FIG. 5. The HUD device 100 includes a light-emitting display 10 and a reflector 30. The light-emitting display 10 and reflector 30 are accommodated in a housing 40 of the HUD device 100.

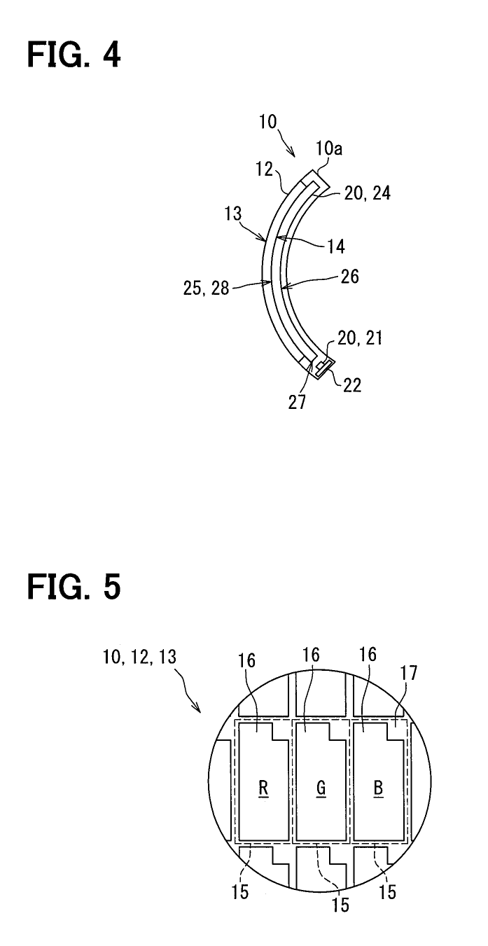

The light-emitting display 10 is a display that has a built-in light source. The light-emitting display 10 of the present embodiment includes a liquid crystal panel 12 and a backlight unit 20 as shown in FIG. 4. The liquid crystal panel 12 and backlight unit 20 are accommodated in a casing 10 a that is opaque such that the display screen 13 of the liquid crystal panel 12 is exposed to the outside.

The liquid crystal panel 12 of the present embodiment is a liquid crystal panel that uses thin film transistors (TFTs), for example, which is a transmissive, active-matrix liquid crystal panel, for example, formed by multiple pixels 15 arrayed in two directions on the display screen 13. Since the liquid crystal panel 12 of the present embodiment has flexibility, in particular, the panel has a curved plate shape, with the display screen 13 being formed as a curved surface.

The liquid crystal panel 12 is a stack of a pair of linear polarizing plates, a liquid crystal layer sandwiched between the pair of linear polarizing plates, and the like. The linear polarizing plates each have a nature of transmitting the light, whose polarizing direction extends along the transmission axis, and of absorbing the light, whose polarizing direction extends along the absorption axis. The pair of linear polarizing plates are disposed such that their transmission axes are orthogonal to each other. The liquid crystal layer can rotate the polarizing direction of the light incident to the liquid crystal layer in accordance with the voltage applied to each of the pixels 15.

As shown to a larger scale in FIG. 5, each pixel 15 is provided with an aperture 16 capable of opening optically, and a wiring 17 surrounding the aperture 16. The aperture 16 of each pixel 15 transmits the light propagating perpendicularly to the contact plane at the opening of the display screen 13 most efficiently. Pixels 15 adjacent to each other are provided with color filters of colors different from each other (e.g., red, green, and blue), to create various colors from combinations of these colors.

The backlight unit 20 illuminates the liquid crystal panel 12 from a back side 14 opposite from the display screen 13. The backlight unit 20 includes a curved light guide plate 24 and a plurality of light-emitting elements 21. The curved light guide plate 24 is formed as a transparent curved plate from glass or synthetic resin, for example. A front side 25 of the curved light guide plate 24 facing the liquid crystal panel 12 has an area substantially the same as the area of the back side 14 of the liquid crystal panel 12. The curved light guide plate 24 is curved in conformity to the curved shape of the liquid crystal panel 12. More specifically, the curvature of the front side 25 is set in accordance with the curvature of the back side 14 of the liquid crystal panel 12, so that the front side 25 of the curved light guide plate 24 is in tight contact with the back side 14 of the liquid crystal panel 12.

The light-emitting elements 21 are aligned to each face a side face 27 of the curved light guide plate 24. The light-emitting elements 21 of the present embodiment are light-emitting diode elements disposed on a light source circuit substrate 22 and electrically connected to a power supply. Each light-emitting element 21 emits an amount of light in accordance with the amount of current as power is applied. More specifically, each light-emitting element 21 realizes emission of quasi white light, for example by a blue light-emitting diode with a fluorescent material cover.

The light from each light-emitting element 21 is emitted into the curved light guide plate 24 through the side face 27. Inside the curved light guide plate 24, the light is reflected by the back side 26 facing the opposite side from the liquid crystal panel 12, and emitted evenly from all over the surface of the liquid crystal panel 12. More particularly, a diffuser film is provided on the front side 25 of the curved light guide plate 24 on the side facing the liquid crystal panel 12, so that light emitted from the curved light guide plate 24 is diffused before entering the liquid crystal panel 12. The curved light guide plate 24 thus forms a curved planar light source 28, and the liquid crystal panel 12 is illuminated by the backlight unit 20 from the back side 14.

The liquid crystal panel 12 controls transmission of the light entering from the back side 14 in each pixel 15 so that an image can be displayed with the light emitted from the display screen 13. The display screen 13 of the light-emitting display 10 thus displays an image by emitting light.

The reflector 30 reflects light from the display screen 13 toward the windshield 3 on the optical path to adjust the state of the formed virtual image VI, as shown in FIG. 2 and FIG. 3. More specifically, the reflector 30 of the present embodiment is formed by a single concave mirror 34.

The concave mirror 34 is composed of a base member made of synthetic resin or glass, for example, with a metal film such as aluminum formed on the surface by vapor deposition or the like as a reflection surface 35. The reflection surface 35 is formed as a smooth curved surface, as the concave mirror 34 has a concavely curved center. Light that has entered the concave mirror 34 from the display screen 13 is reflected by the reflection surface 35 to the windshield 3.

The housing 40 is provided with a window 40a between the concave mirror 34 and the windshield 3. The window 40a is closed by a transparent dust-proof cover 42. Therefore, the image light from the concave mirror 34 passes through the dust-proof cover 42 and reaches the windshield 3, to be reflected there. Thus, the occupant perceives the light reflected by the windshield 3 as the virtual image VI, i.e., can see it.

The concave mirror 34 is rotatable around a rotary shaft 36 coupled to a stepping motor. The reflection surface 35 of the concave mirror 34 is oriented diagonally, rearward and upward of the vehicle. The rotary shaft 36 is disposed to extend along the left and right direction of the vehicle, so that the display position of the virtual image VI can be moved up and down by rotating the shaft and changing the direction of the reflection surface 35. In the present embodiment, the reflection surface 35 of the concave mirror 34 and the display screen 13 of the light-emitting display 10 face each other along the front to back direction of the vehicle.

The reflection surface 35 of the present embodiment is concavely curved to enlarge the virtual image VI. If the display screen 13 were flat, the enlarged virtual image VI would be bent oppositely from the occupant, i.e., concave to the front of the vehicle, because of the field curvature. In the present embodiment, the liquid crystal panel 12 has a center protruded toward the reflector 30, so that the display screen 13 is convexly curved, and this curved surface reduces such bending of the virtual image VI caused by the field curvature.

More specifically, the windshield 3 does not necessarily have a shape optimal for forming a virtual image VI because it is determined by a vehicle maker in consideration of the primary functions of the windshield 3 as well as the design or the like of the vehicle 1. Various aberrations can occur when virtual images VI are formed by reflecting image light on the windshield 3. Therefore, the reflection surface 35 of the present embodiment has a free-form surface with the function of reducing various aberrations caused by the shape or the like of the windshield 3. However, the reflection surface 35 having a free-form surface may result in a complex display distortion in the virtual image VI. Therefore, the display screen 13 has a free-form surface that cancels such a display distortion.

The shape of the display screen 13 only determines the positional relationship of relative display positions among the pixels of the image, i.e., the display screen 13 basically does not refract or reflect the light that forms the virtual image VI. Therefore, the display screen 13 is unlikely to newly cause an aberration such as astigmatism as it corrects the display distortion.

The effects of the first embodiment described above will be explained below.

According to the first embodiment, the display screen 13 of the light-emitting display 10 is formed as a curved surface. The display screen 13 being curved enables reduction of display distortions such as field curvatures and distortion aberrations, for example, and, in combination with the shape and structure of the reflector 30, allows for adjustment of the display size of the virtual image VI. Thus, the HUD device 100 that uses a light-emitting display 10 can realize high visibility of virtual images VI.

According to the first embodiment, the light-emitting display 10 includes a liquid crystal panel 12 and a backlight unit 20. Since the backlight unit 20 illuminates the liquid crystal panel 12 from the back side 14 and images are shown on the curved display screen 13 of the liquid crystal panel 12, high visibility of the virtual images VI can be reliably realized.

According to the first embodiment, the backlight unit 20 includes a curved planar light source 28 in tight contact with the back side 14 of the liquid crystal panel 12. With the planar light source 28 being in tight contact with the back side 14 of the liquid crystal panel 12, the entire screen can be evenly caused to perform luminescent display, even though the display screen 13 is curved. Thus, the display quality of virtual images VI is improved and high visibility can be realized.

According to the first embodiment, the planar light source 28 in tight contact with the back side 14 of the liquid crystal panel 12 is formed by the curved light guide plate 24 in a curved plate shape, to which light from the light-emitting elements 21 enters through the side face 27. Forming the curved light guide plate 24 as a curved surface enables easy production of the planar light source 28 that makes tight contact with the back side 14 of the liquid crystal panel 12, and also facilitates realization of a thinner backlight unit 20. This can realize high visibility of virtual images VI as well as enable easier mounting of the HUD device 100 to the vehicle 1.

According to the first embodiment, the display screen 13 is convexly curved. In this way, display distortion is less likely to occur even though the reflector 30 enlarges the virtual image VI, so that high visibility of the virtual image VI can be realized.

According to the first embodiment, the display screen 13 has a free-form surface. In this way, the possibility of complex display distortion in the virtual image VI is reduced, so that the visibility of the virtual image VI can be improved.

According to the first embodiment, the reflector 30 is formed by one concave mirror 34 that has a concavely curved reflection surface 35 with a recessed center and that reflects light from the display screen 13 by the reflection surface 35 to the windshield 3 to enlarge the virtual image VI. With the display screen 13 being a curved surface, the configuration of the reflector 30 described above can reduce the possibility of display distortion that may result from the enlargement of the virtual image VI. At the same time, the number of components of the reflector 30 is reduced, so that the mounting of the HUD device 100 to the vehicle 1 is made easier, while high visibility of virtual images VI is realized.

Now, the configuration of the present embodiment will be compared with the configurations of Comparative Example 1 and Comparative Example 2.

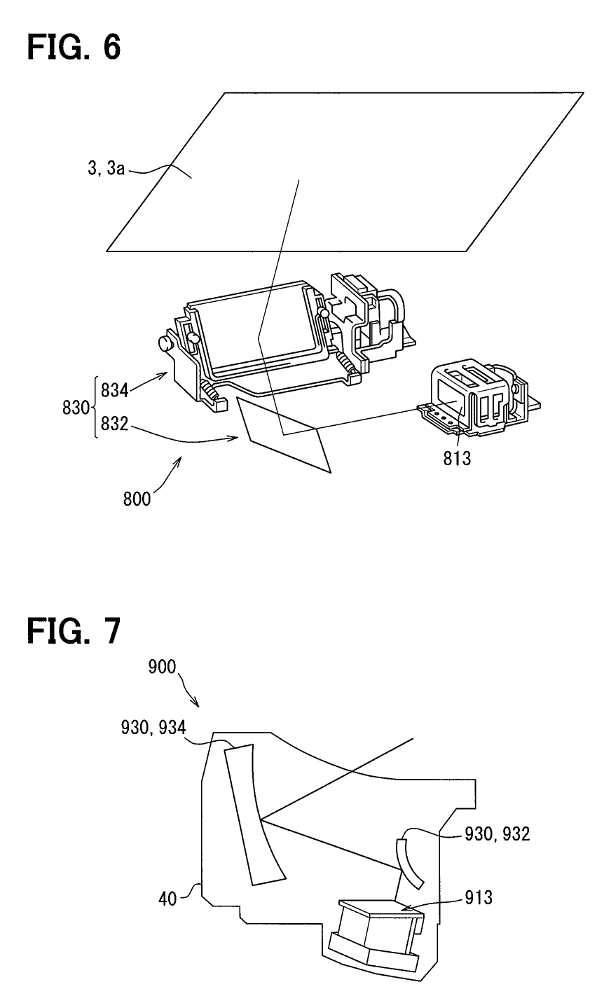

A HUD device 800 of Comparative Example 1 has a display screen 813 that is flat, and a reflector 830 including a plane mirror 832 and a concave mirror 834, as shown in FIG. 6. The plane mirror 832 returns the light from the display screen 813 in a horizontal direction of the image. This HUD device 800 has a volume of about 13 L.

A HUD device 900 according to Comparative Example 2 is an improved version of Comparative Example 1, as shown in FIG. 7. The HUD device 900 of Comparative Example 2 has a display screen 913 that is flat, but a reflector 930 including a convex mirror 932 and a concave mirror 934. The convex mirror 932 returns the light from the display screen 913 in a vertical direction of the image. This HUD device 900 has a volume of about 9 L.

Since the reflector 30 of the HUD device 100 of the present embodiment is formed by a single concave mirror 34, the HUD device 100 has a volume of about 6 L, which is significantly smaller than Comparative Example 2, as can be seen from a comparison between FIG. 2 and FIG. 7.

The comparison results of display distortion in the virtual image VI formed by each configuration are shown in the following table 1.

TABLE 1

| | | Comparative | Comparative | First |
|---|---|---|---|---|
| Item | | Example 1 | Example 2 | Embodiment |
| Additional Mirror | | Plane | Convex | None |
| | | Mirror | Mirror | |
| Display | | Flat | Flat | Curved |
| | | Display | Display | Display |
| Turn | | Horizontal | Vertical | Single |
| | | Turn | Turn | Optical Path |
| 9 Eye Positions | Display Size | 5.50% | 3.5% | 3.5% |
| in Center | Variation | | | |
| of Eyebox | Display | Vertical | Vertical | Vertical |
| | Distortion | Trapezoidal | Trapezoidal | Trapezoidal |
| | | Distortion | Distortion | Distortion |
| | | 9.0 deg | 3.5 deg | 3.5 deg |
| | | Horizontal | Horizontal | Horizontal |
| | | Trapezoidal | Trapezoidal | Trapezoidal |
| | | Distortion | Distortion | Distortion |
| | | 1.5 deg | 1.0 deg | 1.0 deg |
| | | Smile | Smile | Smile |
| | | Distortion | Distortion | Distortion |
| | | 2.5 deg | 2.0 deg | 2.0 deg |
| | Imaging | 0.14 deg | 0.12 deg | 0.12 deg |
| | Spot | | | |
| 9 Eye Positions | Display Size | 15.0% | 10.5% | 10.5% |
| in Upper/Lower | Variation | | | |
| of Eyebox | Display | Vertical | Vertical | Vertical |
| | Distortion | Trapezoidal | Trapezoidal | Trapezoidal |
| | | Distortion | Distortion | Distortion |
| | | 12.5 deg | 5.0 deg | 5.0 deg |
| | | Horizontal | Horizontal | Horizontal |
| | | Trapezoidal | Trapezoidal | Trapezoidal |
| | | Distortion | Distortion | Distortion |
| | | 2.5 deg | 1.0 deg | 1.0 deg |
| | | Smile | Smile | Smile |
| | | Distortion | Distortion | Distortion |
| | | 4.0 deg | 3.0 deg | 3.0 deg |
| | Imaging | 0.17 deg | 0.14 deg | 0.14 deg |
| | Spot | | | |

Table 1 shows that the display size variation and display distortion are both reduced in Comparative Example 2 despite the smaller volume than that of Comparative Example 1. Moreover, the display size variation and display distortion are both maintained in the present embodiment more or less the same as Comparative Example 2 despite the smaller volume than that of Comparative Example 2. Namely, the configuration of the present embodiment achieves both of very high visibility of the virtual image VI and mountability on a mobile body.

### Second Embodiment

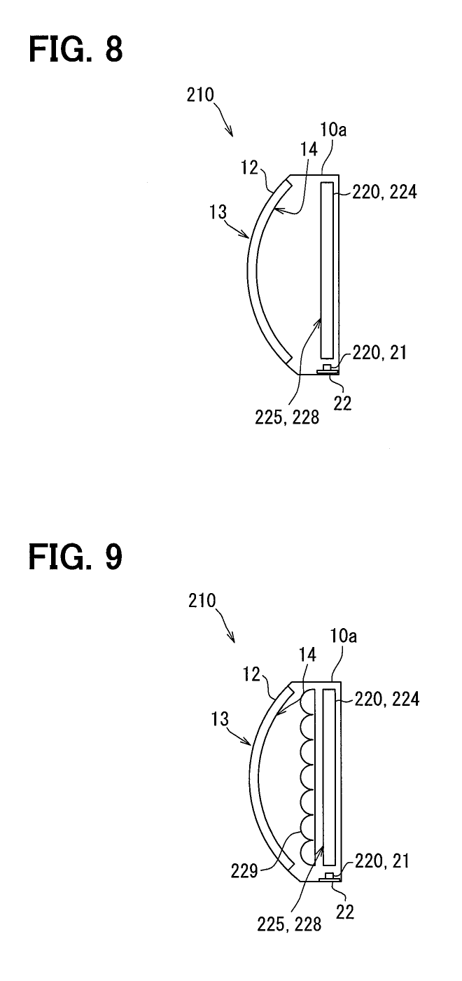

As shown in FIG. 8 and FIG. 9, a second embodiment of the present disclosure is a variation example of the first embodiment. The second embodiment will be described mainly with respect to the features different from the first embodiment.

A light-emitting display 210 of the second embodiment includes a liquid crystal panel 12 and a backlight unit 220, similarly to the first embodiment. The liquid crystal panel 12 of the present embodiment has a curved plate shape, with the display screen 13 formed as a curved surface, similarly to the first embodiment.

The backlight unit 220 of the second embodiment includes a light guide plate 224 and a plurality of light-emitting elements 21. The light guide plate 224 is formed as a transparent flat plate from glass or synthetic resin, for example. A front side 225 of the light guide plate 224 has an area substantially the same as the area of the back side 14 of the liquid crystal panel 12, so that the light guide plate 224 forms a flat planar light source 228. The light guide plate 224 is not in tight contact with the back side 14 of the liquid crystal panel 12 but spaced away from it.

There may be no component between the liquid crystal panel 12 and the light guide plate 224 as shown in FIG. 8, or, the backlight unit 220 may include an optical element 229 between the liquid crystal panel 12 and the light guide plate 224 as shown in FIG. 9. Examples of the optical element 229 include a lens, a diffuser, a polarizing plate, a retardation film, and the like.

According to the second embodiment, the backlight unit 220 includes a flat planar light source 228 spaced away from the back side 14 of the liquid crystal panel 12. With this configuration, since the backlight unit 220 is not dependent on the shape of the liquid crystal panel 12, production is made easier and also an optical element 229 can be disposed between the planar light source 228 and the liquid crystal panel 12, so that high visibility of the virtual image VI can be realized in accordance with the functionality of the optical element 229.

### Third Embodiment

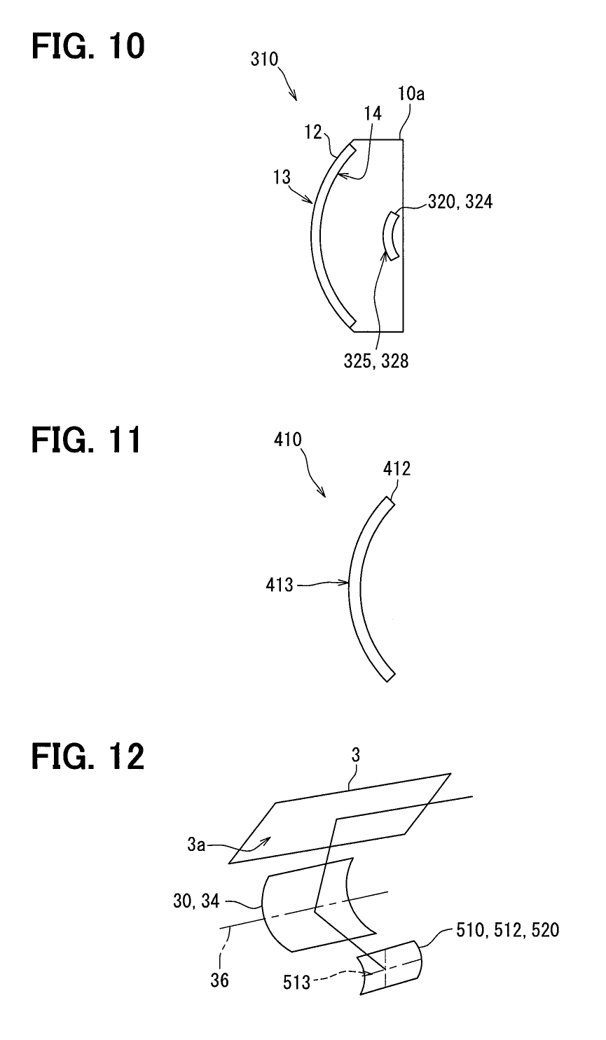

As shown in FIG. 10, a third embodiment of the present disclosure is a variation example of the first embodiment. The third embodiment will be described mainly with respect to the features different from the first embodiment.

A light-emitting display 310 of the third embodiment includes a liquid crystal panel 12 and a backlight unit 320, similarly to the first embodiment. The liquid crystal panel 12 of the present embodiment has a curved plate shape, with the display screen 13 formed as a curved surface, similarly to the first embodiment.

The backlight unit 320 of the third embodiment includes a curved light guide plate 324 and a plurality of light-emitting elements (not shown) that emit light into the side face of the curved light guide plate 324. The curved light guide plate 324 is formed as a transparent curved plate from glass or synthetic resin, for example. However, the front side 325 of the curved light guide plate 324 has an area smaller than the area of the back side 14 of the liquid crystal panel 12. The curved light guide plate 324 forms a curved planar light source 328, similarly to the first embodiment. The curved light guide plate 324 is not in tight contact with the back side 14 of the liquid crystal panel 12 but spaced away from it, similarly to the second embodiment.

The front side 325 of the curved light guide plate 324 on the side facing the liquid crystal panel 12 is formed as a convexly curved surface, as the light guide plate 324 has a center protruding toward the liquid crystal panel 12. Therefore, the light emitted from the curved light guide plate 324 spreads radially as it propagates toward the liquid crystal panel 12 and can illuminate the entire back side 14 of the liquid crystal panel 12. Also, most of the light from the curved light guide plate 324 passes through the liquid crystal panel 12 perpendicularly to the aperture 16.

The backlight unit 320 may have no component between the liquid crystal panel 12 and the curved light guide plate 324 as shown in FIG. 10. Alternatively, the backlight unit 320 may include an optical element similar to that of the second embodiment between the liquid crystal panel 12 and the curved light guide plate 324. Examples of the optical element include a lens, a diffuser, a polarizing plate, a retardation film, and the like.

According to the third embodiment, the backlight unit 320 includes a curved planar light source 328 convex toward the liquid crystal panel 12 and spaced away from the back side 14 of the liquid crystal panel 12. This way, the light from the planar light source 328 spreads as it propagates toward the liquid crystal panel 12, so that the entire display screen 13 can be evenly caused to perform luminescent display. Thus, the display quality of virtual images VI is improved and high visibility can be realized.

### Fourth Embodiment

As shown in FIG. 11, a fourth embodiment of the present disclosure is a variation example of the first embodiment. The fourth embodiment will be described mainly with respect to the features different from the first embodiment.

A light-emitting display 410 of the fourth embodiment is a display with a built-in light source and includes an OLED display 412 as its light-emitting image display panel, in which a display screen 413 is formed by organic light-emitting diodes (OLEDs) arranged in two-dimensional arrays. The organic light-emitting diode elements emit light themselves by the organic electroluminescence phenomenon, so that the display screen 413 itself emits light. Since the OLED display of the present embodiment has flexibility, in particular, the panel has a curved plate shape, with the display screen 413 being formed as a curved surface.

Similarly to the first embodiment, the OLED display 412 of this fourth embodiment has a center protruded toward the reflector 30, so that the display screen 413 is convexly curved, and this curved surface reduces display distortion of the virtual image VI. The display screen 413 is also formed as a free-form surface.

According to the fourth embodiment, the light-emitting display 410 includes the OLED display 412 as a light-emitting image display panel, in which the display screen 413 itself emits light. By adopting the light-emitting image display panel, the backlight unit is no longer needed, so that the light-emitting display 410 can be made thinner. This can realize high visibility of virtual images VI as well as enable easier mounting of the device to the vehicle 1.

### Fifth Embodiment

As shown in FIG. 12, a fifth embodiment of the present disclosure is a variation example of the first embodiment. The fifth embodiment will be described mainly with respect to the features different from those of the first embodiment.

A light-emitting display 510 of the fifth embodiment includes a liquid crystal panel 512 and a backlight unit 520, similarly to the first embodiment. The backlight unit 520 of the present embodiment forms a planar light source in tight contact with the back side of the liquid crystal panel 512, similarly to the first embodiment.

Since the liquid crystal panel 512 of the fifth embodiment has flexibility similarly to the first embodiment, the panel has a curved plate shape, with the display screen 513 being formed as a curved surface. However, the display screen 513 of the fifth embodiment is formed as a concavely curved surface, because the liquid crystal panel 512 has a center recessed oppositely from the reflector 30.

According to the fifth embodiment, the display screen 513 is concavely curved. This enables adjustment of the display size of the virtual image VI in combination with the shape and configuration of the reflector 30, so that high visibility of the virtual image VI can be realized.

### Other Embodiments

While some embodiments of the present disclosure have been described above, the present disclosure should not be interpreted to be limited to these embodiments, and can be applied to various other embodiments and combinations thereof without departing from the scope of the subject matter of the present disclosure.

More specifically, in Variation Example 1, a combiner that is separate from the vehicle 1 may be installed in the vehicle 1 as a projection member, and the image may be projected to the combiner. Alternatively, the HUD device 100 itself may include a combiner as a projection member.

In Variation Example 2, the display screen 13 may have various curved surfaces such as spherical surface or cylindrical surface, other than the free-form surface.

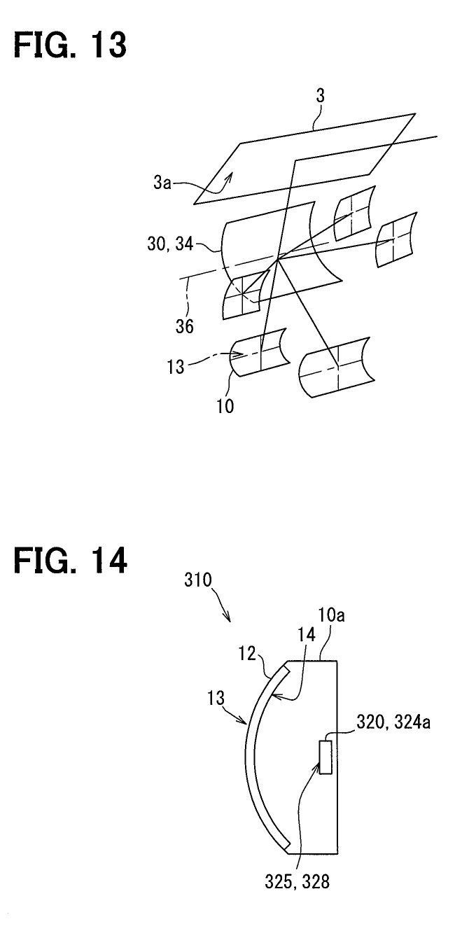

In Variation Example 3, the reflection surface 35 of the concave mirror 34 and the display screen 13 of the light-emitting display 10 need not face each other along the front to back direction of the vehicle. For example, as shown in FIG. 13, the display screen 13 of the light-emitting display 10 may be disposed at a position offset upward, downward, left, or right, relative to the front of the reflection surface 35 of the concave mirror 34 in the front to back direction of the vehicle. Such arrangement may facilitate mounting of the display to the instrument panel 2 of the vehicle 1.

In Variation Example 4, the reflector 30 may adopt other configurations than the single concave mirror 34. For example, the reflector 30 may include a plane mirror as well as the concave mirror 34. Light emitted from the display screen 13 may be reflected by a flat reflection surface of the plane mirror, and the light reflected by the reflection surface of the plane mirror may be reflected by the reflection surface 35 of the concave mirror 34 toward the windshield 3. Alternatively, the reflector 30 may include a convex mirror as well as the concave mirror 34. Also, a cold mirror may be provided on the reflector 30.

In Variation Example 5 associated with the first to third and fifth embodiments, a reflective film may be provided on the back side 26 of the light guide plate 24, and the diffusion film may not be provided on the front side 25 of the light guide plate 24.

In Variation Example 6 associated with the first to third and fifth embodiments, the backlight unit 20 may be configured to direct the light from the light-emitting elements arrayed on the light source circuit substrate directly or via an optical element such as a lens, a diffuser, a polarizing plate, a retardation film, to the liquid crystal panel 12, instead of using the light guide plate 24.

In Variation Example 7 associated with the third embodiment, a flat plate-like light guide plate 324 a having a smaller front side area relative to the area of the back side 14 of the liquid crystal panel 12 may be adopted in place of the curved light guide plate 324, as shown in FIG. 14. In this case, too, the backlight unit 320 may include an optical element between the liquid crystal panel 12 and the light guide plate 324.

In Variation Example 8, the display position of the virtual image VI can be moved by moving the light-emitting display 10 in combination with or in place of the rotation of the rotary shaft 36 of the concave mirror 34. In this case, the entire light-emitting display 10 may be configured to move relative to the reflector 30. In the configurations of the second and third embodiments, the backlight unit 220 may be fixed relative to the reflector 30, and the liquid crystal panel 12 only may be moved relative to the reflector 30.

In Variation Example 9, an electronic paper having a front light or the like, for example, may be adopted as the light-emitting display 10.

In Variation Example 10, the present disclosure may be applied to various mobile bodies (transport equipment) such as ships, planes, and the like, other than the vehicle 1.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A head-up display device mounted on a mobile body and projecting an image to a projection member to display the image as a virtual image visible by an occupant in the mobile body, the head-up display device comprising:
a light-emitting display including a curved display screen and configured to emit light through the curved display screen to display an image; and
a reflector configured to reflect the light from the curved display screen toward the projection member to adjust a formation state of the virtual image, wherein
the light-emitting display includes:
a liquid crystal panel having a curved plate shape and having the curved display screen on a first surface of the liquid crystal panel exposed to an outside of the light-emitting display; and
a backlight unit configured to illuminate the liquid crystal panel from a second surface of the liquid crystal panel opposite from the first surface,
the curved display screen is convex toward the reflector,
the backlight unit includes a curved light guide plate having a curved plate shape and spaced from the second surface of the liquid crystal panel, the curved light guide plate forming a curved planar light source which is convex toward the liquid crystal panel, and
an area of a surface of the curved light guide plate is smaller than an area of the second surface.

2. The head-up display device according to claim 1, wherein the backlight unit further includes a light-emitting element configured to emit light into an edge face of the curved light guide plate to guide the light.

3. The head-up display device according to claim 1, wherein the curved display screen has a free-form surface.

4. The head-up display device according to claim 1, wherein the reflector is a single concave mirror that has a reflection surface concavely curved and having a recessed center, and the reflection surface reflects the light from the curved display screen toward the projection member to enlarge the virtual image.
